(19) United States
(12) Patent Application Publication
(10) Pub. No.: US 2017/0178039 A1
(43) Pub. Date: Jun. 22, 2017

(54) COMPUTER SYSTEM FOR CATASTROPHIC EVENT MANAGEMENT

(71) Applicant: Risk Management Solutions, Inc., Newark, CA (US)

(72) Inventors: Mark Pinkerton, London (GB); Simon Pickett, Oakland, CA (US); Ardavan Motahari, Mountain View, CA (US)

(21) Appl. No.: 15/129,397

(22) PCT Filed: Mar. 26, 2015
(86) PCT No.: PCT/US15/22776

§ 371 Date: Sep. 26, 2016

Related U.S. Application Data
(60) Provisional application No. 61/973,399, filed on Apr. 1, 2014.

(51) Int. Cl. G06Q 10/06; G06Q 50/26

(52) U.S. Cl. CPC G06Q 10/0635; G06Q 10/06315; G06Q 50/26

(57) ABSTRACT

Described computer systems permit computationally efficient, sophisticated analysis and modeling of groups of data items (e.g., data profiles, agreements) in connection with a model to understand and quantify threats posed to resources described by the groups of data items as a whole. This permits involved parties to take appropriate mitigation measures, such as allocation and movement of emergency equipment and personnel, or other resources. The systems are applicable to situations in which there are multiple possible hazards and which involve multiple parties, and thus cannot be conveniently understood manually or efficiently analyzed by conventional computing methods.

### RELATED APPLICATION

This application claims priority to copending provisional application 61/973,399 filed Apr. 1, 2014, the contents of which are incorporated by reference as if fully set forth herein.

### BACKGROUND

The present disclosure relates generally to processing systems, and specifically to processing systems that identify and manage exposures from and responses to catastrophic events, as well as corresponding processes and computer program products.

Catastrophic events present both logistical and financial challenges to the individuals, communities, businesses, and governmental entities impacted. Particularly challenging is creating a response plan for a catastrophic event that is statistically known to occur at a frequency, but whose exact date, location, and magnitude is unknowable.

Because the specific circumstances of an occurrence of a catastrophic event are unknowable, the individuals, communities, businesses, and governmental entities that will be impacted by the event cannot properly plan for the risk posed by the event. For example: resource reserves cannot be accumulated by individuals; businesses cannot take appropriate mitigation measures; governmental entities may not be appropriately staffed or equipped to respond to periodic, but infrequent, catastrophic events that place high demands on an infrastructure built and staffed for a more predictable level of daily activity. Automated processing that leads to an understanding of the levels and sources of possible impacts on infrastructure and resources permits an entity to take appropriate mitigation actions by changing resource allocations, arranging for contingencies in the event of a catastrophe, or reserving resources to recover from a catastrophic event.

It would be advantageous if there were a system to analyze and quantify the level of possible resource impact posed by one or more catastrophic events, enabling entities to appropriately mitigate the these impacts with corresponding resources.

### BRIEF DESCRIPTION OF THE DRAWINGS

FIG. 1A illustrates a system for modeling and analyzing aggregated risk, in an embodiment.

FIG. 1B illustrates a calculation engine of the system shown in FIG. 1A, in an embodiment.

FIG. 2 is a method flow diagram illustrating a method for calculating aggregated risk, in an embodiment.

FIG. 3A is an example risk output object that is a product of a risk query posed to a system for modeling and analyzing aggregated risk, in an embodiment.

FIG. 3B is an illustration of a risk exposure analysis of a set of agreements, in an embodiment.

FIG. 4 illustrates components of an example machine able to read instructions from a machine-readable medium and execute those instructions in a processor.

The figures depict various embodiments of the present disclosure for purposes of illustration only. One skilled in the art will readily recognize from the following discussion that alternative embodiments of the structures and methods illustrated herein may be employed without departing from the principles described herein.

### DETAILED DESCRIPTION

### Overview

Systems and methods of the present disclosure permit sophisticated analysis and modeling of sets of data items (e.g., agreements, data profiles, as appropriate to a particular example) to understand and quantify the aggregated potential resource impact (“risk”) presented by the data items as a whole, under variously modeled conditions. Many of the examples presented below will use the term “agreement” interchangeably for the term “data item.” This is because the term “agreement” is more descriptive of the type of data actually described in the example (i.e., regarding allocation of resources in response to a catastrophe according to previously agreed to roles and responsibilities of emergency response entities.) With this in mind, embodiments of the present disclosure permit the parties to the agreements (instantiated in data items) or other relevant entities to take appropriate mitigation measures. The systems and methods described herein are applicable to situations in which multiple factors threaten various types of property, and which involve multiple parties to the agreements. The complexity of such agreements creates a complicated landscape, the intricacies of which cannot be fully understood by merely reading the agreements or performing simple thought experiments or computed efficiently using conventional computing techniques. Furthermore, the embodiments described herein enable a user to understand risk related to the agreements as whole including average losses, loss variability, and maximum probable loss not otherwise understandable by manually examining the agreements.

In the specific example of a governmental entity, the personnel and equipment necessary to respond to various emergencies can be modeled and analyzed to appropriately staff and equip the entity in preparation for a catastrophe. The models can be executed at varying levels of severity with different types of hazards (e.g., a storm surge compounded by the breaking of a levee).

Regardless of the nature of the entities involved, roles and responsibilities of various entities involved in responding to or remediating a catastrophe are typically defined by multiple agreements. Methods of analysis of multiple agreements, as disclosed herein, include modeling exposure to resources based on sets of agreements as a function of various event models (whether a catastrophe model that generates possible future events or footprints of historical events) and querying, using a risk query language (“RQL”), the aggregated set risk using dimensions of the agreements. Dimensions used to understand the specific aspects of the performance of the sets include terms used to define the various aspects of an agreement including the business line/product type, assets being protected by insurance or emergency response resources, hazards being insured against, characteristics of an insured or an insurance contract, and others. These dimensions need not have a natural hierarchy (such as underwriter, line of business/product type, hazard, government entity, and others), thus enabling sets of agreements, and their corresponding risk exposures, to be modeled in multiple, unrelated ways. For example, exposure of a set of agreements by state, building type, underwriter, and secondary building modifications (e.g., roof tie-downs in hurricane-prone areas) can be identified using these dimensions even though these dimensions are unrelated. Furthermore, the embodiments of the present disclosure enable the execution of analytical operations not otherwise possible for sets of agreements having multiple risk factors and multiple agreements and agreement types.

One feature of the present disclosure is that resources and assets (generically referred to as “risk items”) (e.g., buildings, people, property, and/or financial resources that can be harmed), hazards, and the relationships between them are defined using a uniform nomenclature and a logical structure. Another feature of the present disclosure is that the user interface used to test and model set performance or staffing levels of an emergency responder requires no specialized computer programming knowledge, as it employs a risk query language that is easily understood and used by analysts and operators of the system regardless of their familiarity with computer programming.

A benefit of these features is that the analysis output can be readily understood. Another benefit is that a query of a group of agreements (whether emergency response resources or insurance agreements) can be entered and the analysis easily generated. This facilitates planning exercises performed by emergency response entities (e.g., private entities, state and federal agencies, municipal departments) in identifying their available resources, the function and/or applicability of the resources to various emergencies, the location of the resources, and other features of catastrophe preparedness planning. This also assists insurance companies in analyzing risk exposure, whether to an asset type, a geographic area, or a specific hazard.

The systems and methods described here further provide mechanisms for analyzing data quality, for undertaking exposure analytics, for facilitating open modeling and dynamic data set modeling, and for sharing data relating to such varied uses over cloud systems through simple granting of permissions to access data as the interactions among the data are defined through agreement definition language (“ADL”). These features facilitate, in particular, convenient and transparent emergency response planning between different responding entities, each of which may use different terminology, computer systems, or tools to communicate and plan operations. As a specific example, such applications greatly simplify “what-if” analysis and sensitivity analysis to determine the impact of, for instance, adding coverage for an additional geographic area in which a storm might have impact.

Methods and systems of the present disclosure permit the quick and accurate interpretation of many (whether tens, hundreds, thousands, or even orders of magnitude more) competing and/or overlapping agreements and/or emergency response assets that would not otherwise be interpretable by humans lacking the assistance of a computer applying and/or embodying the methods and systems described herein.

### Risk Query System

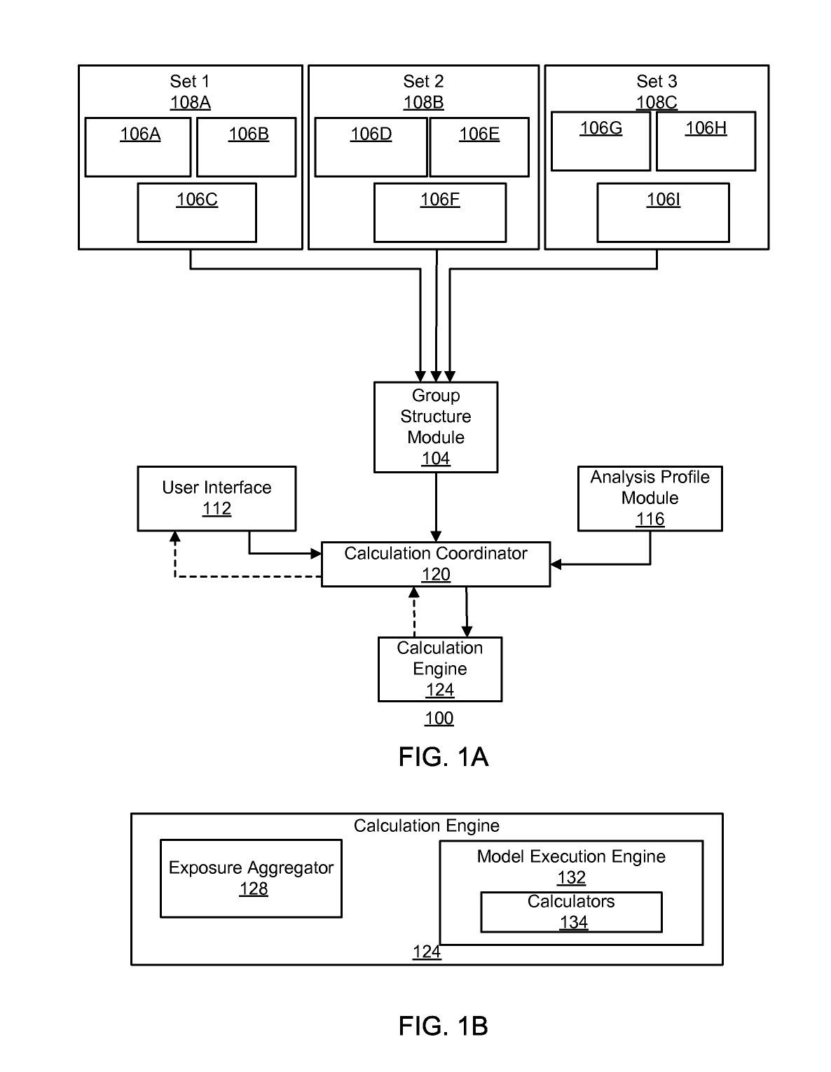

FIG. 1 illustrates an example of a system 100 for analyzing the exposure of one or more sets of data items (or “agreements”) and producing a conveniently understood analytical output. While applicable to a variety of planning situations, the example described below is in the context of insurance. Non-insurance applications of the embodiments herein are also described below. As described above, a benefit of the system 100 is the ability to query and analyze thousands of agreements to understand the overall exposure as a whole.

The system 100 includes a group structure module 104, a user interface module 112, an analysis profile module 116, a calculation coordinator 120, and a calculation engine 124.

As shown in FIG. 1, the group structure module 104 stores a plurality of agreements 106A-I. The agreements 106A-I are collected into sets 108A-C. Each agreement prescribes the variables and conditions under which an event generates a claim (that is, an obligation to the insured to be met by the insurer) under an agreement. For convenience, this prescription is termed a risk exposure or simply an exposure. Events described in the agreements can include physical catastrophes (e.g., floods, hurricanes, and earthquakes) and other types of loss (e.g., operational interruptions and supply chain failures).

The group structure module 104 also stores the relationships between the sets 108A-C, the agreements 106A-I, and their respective exposures. These relationships are used when analyzing the aggregated risk of the sets 108A-C so that the interactions between the various agreements and sets can be understood and analyzed holistically. In this example, defining the relationships is facilitated by constructing the agreements 106A-I using a uniform nomenclature and structure to describe the various agreement terms and exposures. Such a uniform nomenclature and structure is described in U.S. patent application Ser. No. 13/914,774, filed on Jun. 11, 2013, which is hereby incorporated by reference in its entirety. The uniform nomenclature and structure described in U.S. patent application Ser. No. 13/914,774 enables automated processing of various rights and obligations of stakeholders such that they are readily comprehensible to a non-expert in computer programming while at the same time being capable of automatic compilation and processing by a computer to permit repeatable results from identical inputs. In this manner, each stakeholder can independently process various hypothetical or real input conditions to determine the resources and contingencies needed to respond to a wide range of catastrophes.

Using a uniform nomenclature across all agreements in a set and between sets enables relationships between the various exposures and agreement terms to be repeatably searched, identified, analyzed, and understood using the RQL. For example, sets 108A and 108C may both have agreements insuring against inventory loss in warehouses from hurricane damage caused by sustained winds over 100 miles per hour for three hours or more. Understanding the aggregate exposure of these two agreements to this specific event is useful to confirm compliance with underwriting guidelines and to prevent claims that exceed an overall threshold. However, without embodiments of the present disclosure, including the uniform nomenclature and the RQL, the aggregate exposure may be obscured by the magnitude of thousands or hundreds of thousands of agreements held in hundreds of sets.

The RQL is used to put queries to the system to understand interactions between agreements, or profiles stored by (or in communication with) the group structure module 104. One benefit of such a language is, as mentioned above, simplicity and accessibility to those not familiar with computer programming or sophisticated catastrophe modeling concepts. Another benefit is that RQL is configured to permit easy “what if” analyses of the various sets using un-related dimensions, as described herein, even to those not familiar with catastrophe models or the configuration of such models.

In some examples, the RQL is a domain specific language (“DSL”) defined using Backus-Naur From (“BNF”) syntax. For example, an RQL query of the system 100 includes a “Select Block,” an “Applies to Block,” an “OutputBy Block,” and a “Where Block.” In this example, the “Select Block” contains metrics used as inputs by the agreements or portfolios in the system. Metrics are segmented by the structure items defined in the “Applies to Block” and the dimensions specified in the “Output By” block. The “Applies to Block” specifies sets and/or final positions in a group structure at which metrics are to be calculated.

The “Output By Block” specifies one or more dimensions of the output of the query. That is, metrics produced by the query can be segmented, organized, or otherwise partitioned by various dimensions, including agreement attributes, risk item attributes, and event characteristics. Examples of the dimensions include, but are not limited to, general attributes (e.g., peril, peril-region), working attributes (e.g., agreement type, agreement underwriter, product line, effective states, expiration date), geographic attributes (e.g., postal code, country, administrative district, city), and vulnerability attributes (e.g., risk item exposure type, year built, structure type, structure size, occupancy). The “Where Block” specifies filters on various attributes, such as dates (of an event, of an agreement, etc.) or locations of an event.

Returning to the Group Structure Module 104, relationships between agreements and sets of agreements are defined using various agreement or agreement elements. For example, the relationships between individual agreements, how the individual agreements are grouped, and the relationships between the various groups are defined in the group structure module 104. Examples of relationships include, but are not limited to, hazard, geographic area, political area, agreement type (e.g., ground up loss, or gross perspective), agreement owner, and the organizational unit responsible for the individual agreement or group. Aggregating the exposure based on one or more of these relationships provides a level of detailed analysis for large collections of extremely complicated agreements. These relationships then facilitate RQL queries to provide a holistic understanding of exposure to, for example, a community, region, or insurance portfolio.

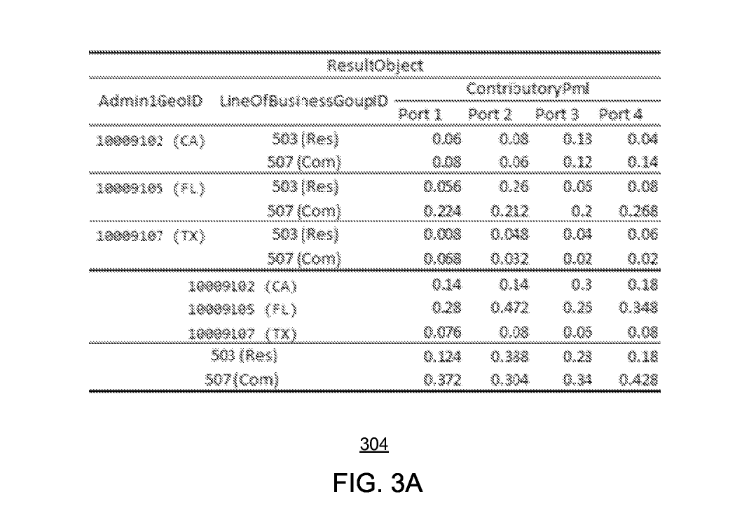

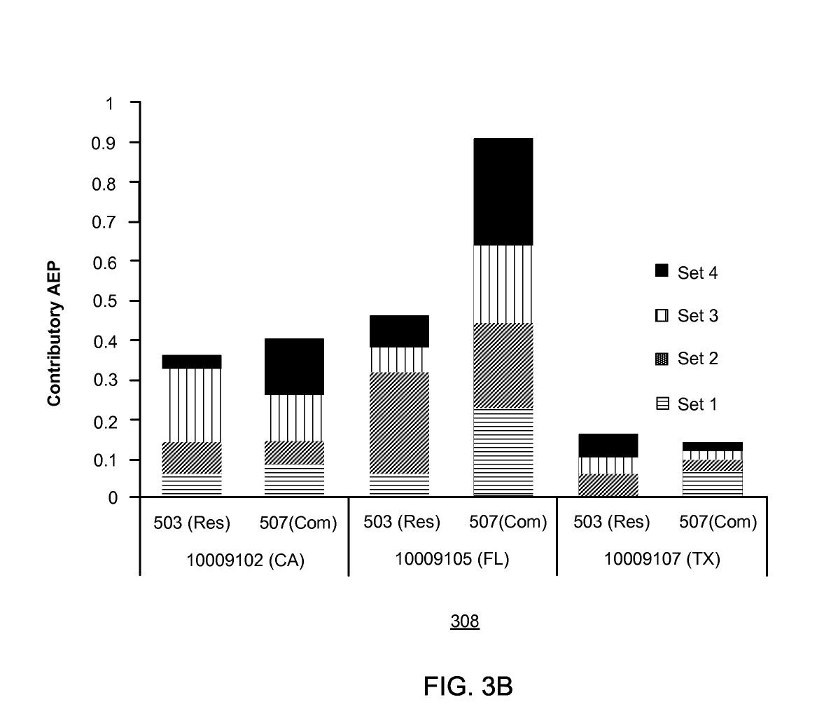

The user interface module 112 receives user inputs and displays results from the set analysis. One example of user inputs received by the user interface module 112 includes event variables used to empirically evaluate the claims arising from an event. For example, a responsible party can identify the aggregate exposure across one or more sets resulting from a class of storm and/or a geographic region impacted by a storm. The sensitivity of the aggregate exposure can be understood by changing, for example, any of the wind speed, wind duration, or geographic area. The results of this analysis are then displayed to the user, an example of which is presented in FIG. 3.

In the illustrated embodiment, the user inputs of event variables are provided to the analysis profile module 116, which stores and executes catastrophe models and event footprints using the provided event variables. One benefit of the analysis profile module 116 is that catastrophe models are not rigidly fixed, but can be tailored by the user by changing event variables. For example, a one-hundred year floor model can be executed and re-executed by changing water volume, flow rate, and other event variables that are not normally changeable by a user of the model. Similarly, bespoke event footprints can be created for events that do not have pre-existing or industry standard catastrophe models, thereby expanding the utility of the system 100 by covering more types of events.

The calculation coordinator 120 is used to identify and select an appropriate calculator for calculating a result for each of the agreements in a set (or sets). That is, because of the wide variation in the types of agreements, the exposure of an agreement is generally calculated by a calculator adapted for those exposures. The calculation coordinator 120 then determines the types of exposures, events, and event variables prescribed in an agreement. Having thus determined the agreement type, exposures, events, and event variables (facilitated by the uniform terminology described above), the calculation coordinator 116 can identify and select a calculator in the calculation engine 124 appropriate for calculating the exposure of the agreement.

In this example, the calculation engine 124 includes an exposure aggregator 128, and a model execution engine 132, which includes various calculators 134.

The model execution engine 132 performs several functions. One function of the model execution engine 132 is the identification of appropriate calculators 134 to use in calculating the exposures of the agreements and/or sets of agreements identified by the RQL query posed by the user. Each calculator 134 of the model execution engine is in communication with the analysis profile module 116, so that the results of an executed catastrophe model can be used by the calculated to generate the modeled losses (i.e., the calculated exposures).

Each calculator 134 includes statistics calculators for performing statistical analysis on the modeled losses. An example of a statistic calculator is occurrence exceedence probability (“OEP”), which is the probability that one or more events generate a loss exceeding a specified threshold in a given time period; and aggregate exceedence probability (“AEP”), which the probability of the total event losses exceeds a threshold in a given time period. One example statistical calculation, for illustration, is determining the probability of exhausting resource reserves. Calculator selection depends on the RQL statement and the specific metrics being requested. Different questions will require different calculation engines to run. The user, by requesting certain outputs under certain conditions using a risk query language query, provides the information to the calculation coordinator 120 used to select the appropriate calculator. As described above, a benefit of this is that the user need only request the information of interest without having a sophisticated analysis of computer science or risk modeling.

The exposure aggregator 128 collects (or identifies as belonging to a similar type of) results according to a query posed by a user produced by calculations performed on agreements 106A-I across ets 108A-C and the various agreements in light of the information and query received through the user interface 112. Because the agreements 106A-I are expressed in the uniform nomenclature of agreement definition language, as are the risk models, and the query expressed in a risk query language, the conditions determining a calculator selection are transparent to the exposure aggregator 128.

Upon the exposure aggregator 128 identifying the appropriate calculators of the calculation engine 124, the model execution engine 132 then provides any inputs to the appropriate calculators, and communicates with the various calculators in the calculation engine 124 as needed in order to execute the various risk models as queried.

### Method for Analyzing Agreement Exposures

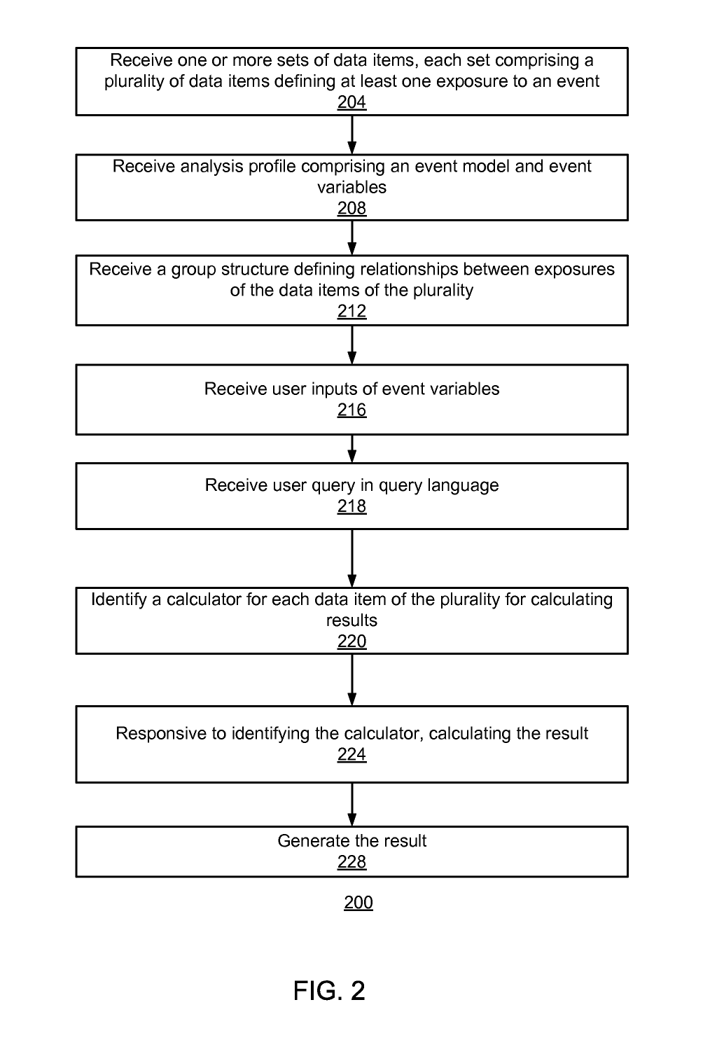

FIG. 2 illustrates a method 200 for analyzing exposures of agreements, and the interactions between agreements. As described above, one or more ets of agreements are received 204. Each sets includes a plurality of agreements, each of which describes at least one exposure to at least one risk event. Examples of agreements in this context include, for example, an insurance amount provided by an insurer for a set of buildings in a geographic area against an event causing a specified level of loss to the insured. Because insurers (and re-insurers) can have hundreds, thousands, tens of thousands, or even millions of agreements covering different risk items and risk events, the exposure presented to the insurer by the agreements as a whole cannot be understood using traditional methods or manual inspection.

While the term “agreement” is used in this example for convenience, this term is not limiting. The concept of an “agreement” also includes the more generic concept of a profile, in which a description or a set of particulars about an individual or an organization are documented. A profile can include a health profile of an individual, a set of building and infrastructure descriptions in a town, or responsibilities and/or capabilities of an emergency responder for responding to a catastrophe. This type of application is described separately below.

Risk analysis profiles comprising an event model and event variables are also received 208 in the method 200. While the sets and agreements received 204 describe the duties and obligations between parties related to an event and the risk exposures of the parties, the risk analysis profiles received 208 include dynamic descriptions of events (i.e., event models) and the variables used in the models. Thus, upon a model being provided with values for variables (e.g., maximum wind speed and wind duration of a named wind storm), as is described below, users can model various event conditions and how the conditions effect the risk exposure.

A group structure is received 212 in the method 200. As described above in the context of FIG. 1, the group structure defines the relationships between sets 108A-C, the agreements 106A-I, and their respective risk exposures. Because these interactions identify the connections between the various sets, agreements, and risk exposures, an analysis of exposures can encompass hundreds, thousands, or tens of thousands of agreements that would not otherwise be possible using traditional computational or manual methods.

Having thus received 204-212 the above-described elements, input values of event variables are received 216. These inputs describe the conditions of the risk event posing a risk to a risk item (e.g., property, operational continuity, critical infrastructure, communications systems). Furthermore, because a user need only provide input values, the user has the power to successively test various event conditions, thereby engaging in a convenient “what-if” analysis of various scenarios. This can be used to understand the event conditions that could threaten the ability of an entity (e.g., an emergency responder or governmental entity) to satisfy its obligations. Similarly, the “what-if” analysis can be used by disaster planning organizations or emergency responders to understand the limits of their responsiveness under various event conditions.

A risk query 218 is then received by the system 100. The risk query, described above, includes various dimensions by which the system 100 will analyze the risk exposure posed by the sets of agreements.

The information received 204-218 is used to identify an appropriate calculator to calculate the risk exposure for each agreement of each set. This is accomplished by using uniform agreement definition language and risk query language so that an appropriate calculator is identified for each agreement. A calculator is selected based on a number of features and the relationship of the features of the query and the agreements being queried. Examples of features used to select one or more specific calculators include the output sought (as indicated in the risk query language statement) and the specific metrics sought as output. One benefit of this, as explained above, is that the user need not have a sophisticated knowledge of computer science or risk modeling to pose the risk query. Another feature used to select a calculator is a type of statistical calculation to be performed on modeled losses.

The risk result is calculated 224 for each agreement using the executable agreement in agreement definition language, the input variables, and the calculation. These results are then aggregated to produce a risk result according to the risk query in risk query language.

As shown in FIG. 3A, a result in the form of a result object 304 is generated in response to the RQL query submission and quantifies an exposure calculated per the provided dimensions. As described above, metrics calculated by the system and organized by dimension specified in the “Output By Block” of the RQL query are the products of the query. In this example, the dimensions of sets 1-4 include geography (i.e., the states of California, Florida, and Texas), and organizational unitor product type. The result object identifies the exposure for each set according to the dimensions submitted in the query using RQL.

FIG. 3B illustrates a different type of result object identifying the various contributions of the set to the exposure. This graphical result object 308, compared to the tabular result object 304, can facilitate comparisons between set for the queried dimensions and can even be used as a graphical dashboard in some applications.

### Project Planning Examples

Embodiments of the present disclosure are also applicable to other contexts including, but not limited to, operational planning, research and development planning, and other applications in which a variety of related factors can be analyzed in parallel to determine risks and benefits of a executing a particular plan. For example, embodiments described herein can be used to determine a course for selecting a path for public health policies or medical research by identifying risks and potential benefits, and comparing opportunity costs between various options.

For example, one or more collections (i.e., a collection being an analog of a set) of anonymous health profiles (i.e., a health profile being an analog to an agreement) can be placed in communication with the system. Similarly, various risk profiles can be placed in communication with the system. These risk profiles can include pandemic simulations, water quality assessments, mortality data as a function of health risk factor (e.g., smoking, access to adequate nutrition, access to potable water, access to sanitation). Similarly, various models (whether for mortality, health expenditures, disease transmission, etc.) can be identified by the calculation engine.

Having thus provided the system with analogues for the various elements described in the context of FIGS. 1A and 1B, a “what if” analysis using RQL can be executed in order to analyze the effect of a particular health policy effort on the health of the populations represented by the various sets of health profiles. A similar configuration could be used by an organization to determine potential health benefits of several different research and development projects, selecting the one project having the most significant health benefit.

Similarly, other embodiments of the present disclosure can be used by governmental entities for public works planning. For example, in place of agreements, the sets can include maps that describe the locations of housing around various navigable and non-navigable waterways in a population area. Using flooding risk models, property damage calculators and flood-related death mortality models, the systems of the present disclosure are used to determine the potential benefit of building various flood mitigation structures. Based on the results, the mitigation structures providing the most benefit (or a maximum of benefit per dollar spent) can be determined. Similar examples exist for quantifying or modeling the benefit of other risk-mitigation activities, such as determining the cost-benefit analysis of retrofitting buildings to withstand earthquakes or hurricanes.

Other examples metrics that can be modeled under various event conditions include, but are not limited to, an expected number of people made homeless by a hazard, a vaccine amount needed to vaccinate a population, and a probability of key infrastructure failing in light of a set of event conditions (e.g., an earthquake of a given magnitude).

In preparation for a catastrophe, or as part of routine planning, the event parameters (such as wind speed, flood level population density, etc.) are provided to the event model from the user interface. Event elements not ordinarily included in catastrophe models may also be added, such as fire risk (e.g., from a power failure at a refinery) in the event of sustained winds from a hurricane causing a power loss. This information is than analyzed in light of the previously stored relationships, resources, and response jurisdictions available to respond. By analyzing the resources that can be applied compared to the damage of the modeled catastrophe, an emergency responder can better understand the risks posed by a threat and build appropriate contingency plans.

Another planning and/or modeling example to which embodiments of the present disclosure can be applied includes life and health models used to determine effects of factors on population health. Such a model can be used to select research programs having potential for greater health benefits or used to select programs having a favorable cost/benefit ratio. Similarly, embodiments described herein can be used to determine positive results of risk mitigation strategies (e.g., the positive effects of flood mitigation projects given various flooding conditions) compared to costs for a given project. Such projects can be difficult to justify given that the benefits often damage or costs avoided in the event of a disaster. Embodiments described herein can be used to quantify or estimate the value of the risk mitigation in the context of the damage caused without the mitigation. Examples include earthquake retrofits to buildings, levees or flood control structures, and structural and/or landscape changes to mitigate the effects of hurricanes.

### Computing Machine Architecture

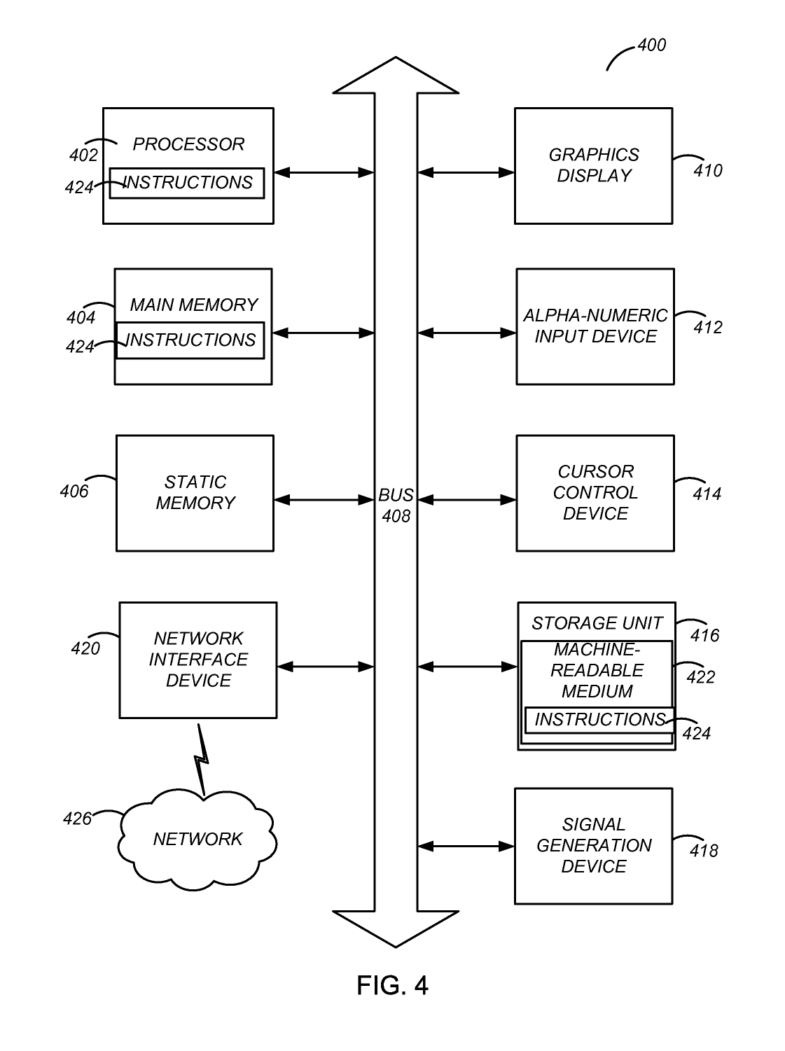

FIG. 4 is a block diagram illustrating components of an example machine able to read instructions from a machine-readable medium and execute those instructions in a processor to perform the machine processing tasks discussed herein, such as the engine operations discussed above. Specifically, FIG. 4 shows a diagrammatic representation of a machine in the example form of a computer system 400 within which instructions 424 (e.g., software) for causing the machine to perform any one or more of the methodologies discussed herein may be executed. In alternative embodiments, the machine operates as a standalone device or may be connected (e.g., networked) to other machines, for instance via the Internet. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include graphics display unit 410 (e.g., a plasma display panel (PDP), a liquid crystal display (LCD), a projector, or a cathode ray tube (CRT)). The computer system 400 may also include alphanumeric input device 412 (e.g., a keyboard), a cursor control device 414 (e.g., a mouse, a trackball, a joystick, a motion sensor, or other pointing instrument), a data store 416, a signal generation device 418 (e.g., a speaker), an audio input device 426 (e.g., a microphone) and a network interface device 420, which also are configured to communicate via the bus 408.

The data store 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network (not shown) via network interface 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but should not be limited to, data repositories in the form of solid-state memories, optical media, and magnetic media.

In this description, the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules as implemented by software, they are stored on a computer readable persistent storage device (e.g., hard disk), loaded into the memory, and executed by one or more processors as described above in connection with FIG. 4. Alternatively, hardware or software modules may be stored elsewhere within a computing system.

As referenced herein, a computer or computing system includes hardware elements used for the operations described here regardless of specific reference in FIG. 4 to such elements, including for example one or more processors, high speed memory, hard disk storage and backup, network interfaces and protocols, input devices for data entry, and output devices for display, printing, or other presentations of data. Numerous variations from the system architecture specified herein are possible. The components of such systems and their respective functionalities can be combined or redistributed.

### Additional Considerations

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs executed by a processor, equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience. This description should be read to include one or at least one and the singular also includes the plural unless it is obvious that it is meant otherwise.

Upon reading this disclosure, those of skill in the art will appreciate still additional alternative structural and functional designs for a system for providing machine processing of resource allocations in response to a catastrophic event through the disclosed principles herein, as well as corresponding methods and computer program products. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems disclosed herein without departing from the spirit and scope of the disclosure.

What is claimed is:

1. A system comprising:
a group structure module for storing one or more sets, each set comprising a plurality of profiles defining exposures to an event, the group structure module also comprising a plurality of relationships between the exposures of the one or more sets;
an analysis profile module for storing an event model and event variables for use with the event model;
a calculation coordinator for selecting a calculator for each profile of the plurality selected for calculation;
a calculation engine for calculating a result for the one or more sets, the calculation engine comprising:
non-transitory machine readable storage medium for storing a plurality of calculators for calculating results;
a processor for calculating a result using a profile of the plurality of profiles in a set, a calculator selected for use with the profile by the calculation coordinator, the event model, and user inputs of the event variables for execution of the event model;
a user interface configured to:
receive user inputs provided by a user for performing an analysis of the set;
receive a query in a query language for querying exposures of the sets of profiles for a dimension;
display calculation result produced responsive to the query terms, the analysis profile, and the one or more sets from the group structure module; and
an exposure aggregator for generating an aggregated result for the one or more sets using the group structure and the calculated results.

2. The system of claim 1, wherein each profile of the plurality is written using an agreement definition language.

3. The system of claim 1, wherein the at least one dimension is used to identify a performance of the one or more sets.

4. The system of claim 1, wherein the at least one dimension comprises multiple dimensions un-related by a hierarchical relationship.

5. The system of claim 1, wherein the query comprises:
a block identifying at least one agreement metric input; and
a set of the at least one agreements to which the query applies.

6. A computer program product stored on a computer-readable medium that, when loaded into memory, causes a processor to perform a method, the method comprising:
receiving one or more sets, each set comprising a plurality of health profiles, each health profile including a plurality of health factors of individuals used to determine a mortality rate;
receiving a risk analysis profile comprising a mortality model and at least one mortality variable for use with the mortality model;
receiving a group structure defining relationships between the health profiles and the health factors of the health profiles of the plurality;
receiving user inputs of event variables for executing the mortality model;
receiving a risk query in risk query language, the query identifying at least one dimension;
identifying at least one calculator of a plurality of calculators for calculating a mortality estimate for each of the plurality of subject profiles according to the user query;
responsive to identifying the calculator for each of the plurality of subject profiles, calculating the mortality estimate for each health profile of the plurality using the corresponding calculator, the user inputs of the event variables, the risk query, and the event model; and
generating an aggregated mortality rate for the queried dimension for the one or more sets using the group structure and the calculated risk results.

7. The method of claim 6, wherein each set of the plurality is written using an agreement definition language.

8. The method of claim 6, wherein the at least one dimension is used to identify risk performance of the one or more sets.

9. The method of claim 6, wherein the at least one dimension comprises multiple dimensions un-related by a hierarchical relationship.

10. The method of claim 6, wherein the risk query comprises:
a block identifying at least one agreement metric input; and
a set of the at least one health profile to which the risk query applies.

11. A computer program product stored on a computer-readable medium that, when loaded into memory, causes a processor to perform a method, the method comprising:
receiving one or more sets, each set comprising a plurality of agreements, each agreement defining at least one risk exposure to an event;
receiving a risk analysis profile comprising an event model and at least one event variable for use with the event model;
receiving a group structure defining relationships between risk exposures of the agreements of the plurality;
receiving user inputs of event variables for executing the event model;
receiving a risk query in risk query language, the risk query identifying at least one dimension;
identifying at least one calculator of a plurality of calculators for calculating a risk result for each of the plurality of agreements according to the risk query;
responsive to identifying the calculator for each of the plurality of agreements, calculating the risk result for each agreement of the plurality using the corresponding calculator, the user inputs of the event variables, the risk query, and the event model; and
generating an aggregated risk result for the queried dimension for the one or more sets using the group structure and the calculated risk results.

12. The method of claim 11, wherein each agreement of the plurality is written using an agreement definition language.

13. The method of claim 11, wherein the at least one dimension is used to identify risk performance of the one or more sets.

14. The method of claim 11, wherein the at least one dimension comprises multiple dimensions un-related by a hierarchical relationship.

15. The method of claim 11, wherein the risk query comprises:
a block identifying at least one agreement metric input; and
a set of the at least one agreements to which the risk query applies.

16. The method of claim 15, wherein the risk query further comprises a position of the at least one set in the group structure at which the query is to be calculated.
